(19) United States
(12) Patent Application Publication
(10) Pub. No.: US 2025/0045800 A1
(43) Pub. Date: Feb. 6, 2025

(54) SYSTEM AND METHOD FOR PLACING ADVERTISING CONTENT AS A VIRTUAL BACKGROUND IN A VIDEOCONFERENCING APPARATUS

(71) Applicant: Mitel Networks Corporation, Kanata (CA)

(72) Inventors: Logendra Naidoo, Ottawa (CA); Tejas Kanduri Aswathanarayana Murthy, Bangalore (IN)

(73) Assignee: Mitel Networks Corporation, Kanata (CA)

(21) Appl. No.: 18/228,488

(22) Filed: Jul. 31, 2023

(51) Int. Cl. G06Q 30/0251; G06F 3/01; G06F 3/0482; G06F 3/14; G06Q 30/0241; G06Q 50/00; G06T 11/00; G06T 13/20; H04L 65/1089

(52) U.S. Cl. CPC G06Q 30/0269; G06F 3/013; G06F 3/017; G06F 3/0482; G06F 3/1454; G06Q 30/0255; G06Q 30/0277; G06Q 50/01; G06T 11/00; G06T 13/205; H04L 65/1089; G06T 2200/24

(57) ABSTRACT

A videoconferencing system and method are configured to generate a video conference including background advertising for one or more conference participants preferably based on an advertising sentiment for each participant. The system may include an advertising engine configured to communicate with advertising sources, a videoconferencing server in communication with the advertising engine and configured to generate a video conference, and an advertising sentiment processor that (a) determines an advertising sentiment for each of the one or more conference participants, and (b) selects unique advertising for each of the one or more of the conference participants based on the advertising sentiment, wherein the advertising sentiment processor is in communication with the advertising engine and with the video conferencing server.

### BACKGROUND

Most collaboration tools support videoconferencing, provide work from home options, and videoconferencing usage has increased over the past several years. Yet, people (also called “users” or “participants”) have few options to select backgrounds of their choice or to have backgrounds present them with information, such as advertisements, in which they are interested.

One existing background format uses static images that may be provided by corporate sales/marketing teams to be inserted into a videoconference.

Some videoconference systems provide ways to blur backgrounds for extra privacy. The blur feature allows a user to keep his/her face and body in focus, while blurring everything else such as the surroundings behind the user. Further, a user may be permitted to add an image or video as an alternative background behind him/her.

### SUMMARY

The present disclosure is of a system and method that learns a sentiment of videoconference participants and that is configured to automatically change the videoconference background of each participant based on the sentiment of the participant. The background may be unique to each participant and is preferably a type of advertising.

A system and method according to this disclosure can generate revenue from ad content for both videoconferencing providers and enterprises that provide advertising content. The advertising presented during the videoconference may be dynamically updated based on changes in a user's sentiment (e.g., based on written, spoken, or online activity, or by observing a user's reaction to the videoconference) and/or the videoconferencing content. The advertising content is made available to videoconference participants in any suitable manner, such as by one or more of video, text, audio, and/or images, is preferably retrieved from one or more advertising sources, and the advertising may be presented at any suitable position in the videoconference, such as at the bottom, top, background, and/or one or more corners.

### BRIEF DESCRIPTION OF THE DRAWING FIGURES

The subject matter of the present disclosure is particularly pointed out and distinctly claimed in the concluding portion of this specification. A more complete understanding of the present disclosure, however, may best be obtained by referring to the detailed description and claims when considered in connection with the drawing figures, wherein like numerals denote like elements and wherein:

FIG. 1 illustrates a videoconferencing system according to aspects of this disclosure.

FIG. 2 illustrates an alternate videoconferencing system according to aspects of this disclosure.

FIG. 3 illustrates a method according to aspects of this disclosure.

FIG. 4 illustrates a user utilizing a system or method according to this disclosure.

FIG. 5 illustrates a screen shot of a videoconference according to systems and methods of this disclosure.

FIG. 6 illustrates an alternate method according to this disclosure.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present invention.

### DETAILED DESCRIPTION

This disclosure is of a system and method that locates and places advertising content into a videoconference, wherein the advertising content may be predicated on each meeting participant's advertising sentiments. The sentiments may be extracted in part from a participant's web-browsing or e-commerce habits but are preferably derived totally or mostly from a participant's communication artifacts that typically are not considered when determining advertising sentiment and content.

As used herein, the terms application, module, analyser, and the like can refer to computer program instructions, encoded on computer storage medium for execution by, or to control the operation of, data processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium is non-transitory and can also be, or be included in, one or more separate physical components or media (e.g., solid-state memory that forms part of a device, disks, or other storage devices).

As used herein, “engine” refers to a data-processing apparatus, such as a processor, configured to execute computer program instructions, encoded on computer storage medium, wherein the instructions control the operation of the engine. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., solid-state memory that forms part of a device, disks, or other storage devices). In accordance with examples of the disclosure, a non-transient computer readable medium containing program can perform functions of one or more methods, modules, engines and/or other system components as described herein.

As used herein, “database” refers to any suitable database for storing information, electronic files or code to be utilized to practice embodiments of this disclosure. As used herein, “server” refers to any suitable server, computer or computing device for performing functions utilized to practice embodiments of this disclosure. Users join a meeting via their preferred collaboration tool for e.g., MiTeam Meetings, Zoom, Microsoft Teams etc.

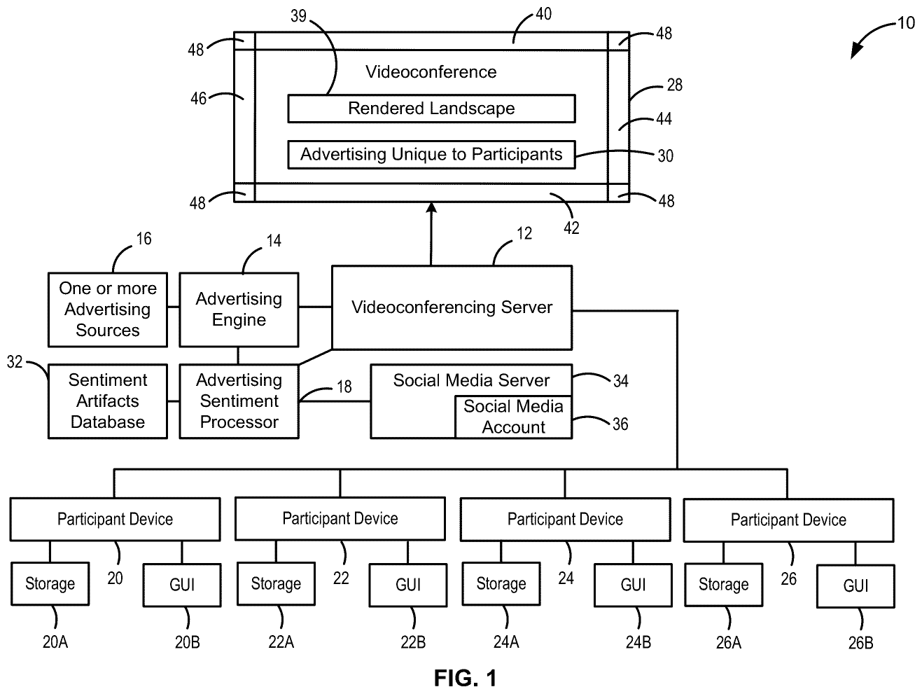

Turning now to the Figures, FIG. 1 shows a system 10 according to aspects of this disclosure. A videoconferencing server 12, which can be any type of server(s), computer(s), or processor(s), is in communication with an advertising engine 14, which can be any type of server(s), computer(s), or processor(s), that is in communication with and can access one or more advertising sources 16. Advertising sources 16 can be, for example, the internet, one or more social media platforms, and/or one or more organizational databases. Advertising engine 14 is also in communication with advertising sentiment processor 18, which determines an advertising sentiment for at least one videoconference participant.

Videoconferencing server 12 is also in communication with one or more participant devices 20, 22, 24, and 26, each of which has a respective storage 20A, 22A, 24A, and 26A, and each of which also has a respective graphical user interface (GUI) 20B, 22D, 24B, and 26B. Videoconferencing server 12 generates a videoconference 28 and makes it available to all participant devices 20, 22, 24, and/or 26 of participants in videoconference 28.

When system 10 is in use, videoconference server 12 causes a videoconference 28 to be generated, which can be viewed by each respective participant of a participant device 20, 22, 24, and/or 26. As the videoconference 28 proceeds videoconferencing server 12 can provide the videoconference information, such as text, headings, images, sounds, and topics to advertising engine 14, which can access the one or more advertising sources 16 and select advertising related to the videoconference information and place the advertising in the videoconference 28 in a manner such that the videoconference 28 is not interrupted. For example, the advertising may be in a rendered landscape 39, a top banner 40, a bottom banner 42, a right-side banner 44, a left side banner 46, and/or one of corners 48. The advertising engine 14 is configured to cause the videoconferencing server 12 to display the background advertising as one or more of (1) a virtual agent that uses or discusses a product or service, (2) an image, (3) a video, (4) text, and/or (5) audio.

The advertising could be minimized or closed by a participant utilizing his/her participant device 20, 22, 24, 26.

The advertising sentiment processor 18 determines an advertising sentiment for at least one, and preferably for each, videoconference participant. Advertising sentiment processor 18 obtains information about a participant's sentiment about a videoconference topic, communicates the sentiment to the advertising engine 14, and advertising engine 14 queries the one or more advertising sources 16 to obtain advertising related to the sentiment and videoconference server 12 displays it in the videoconference 28. Advertising sentiment processor 18 may be used instead of or in combination with the videoconference information to select advertising for a participant.

The advertising sentiment processor 18 can determine a participant's advertising sentiment in a number of ways, such as by obtaining from sentiment artifacts database 32 one or more of (1) the participant's communication artifacts obtained from various communication-related applications such as Outlook® email, Microsoft® Teams meetings or other videoconferencing software, Outlook® calendar, texts, chats, and other artifacts of the participant's organization or social communications; this step may include translating the spoken language components of the communication artifacts to obtain text metadata in order to better search the one or more advertising sources 16 to locate targeted advertising, (2) the participant's designation (e.g., organizational title and/or meeting host or promoter), (3) content currently being spoken during the videoconference, (4) videoconference information artifacts (titles, headings, agenda, presentations, text, video, and/or images within the videoconference 28), (5) outside context of a participant, such as one or more of: (a) social media context; (b) one or more chat forums (e.g., an agent on a website); and (c) instant messaging, and (6) observing the participant's reaction to videoconference topics; such as alertness or speaking, which would indicate interest, or not watching or using/reviewing email, which would indicate lack of interest.

The advertising sentiment artifacts may be stored in sentiment artifacts database 32. Sentiment artifacts database 32 could also include one or more of the participant's: (1) education, (2) work experience, (3) hobbies, (4) friends, (5) travel experiences and locations, (6) address, (7) age, (8) biometrics, (9) social media information, (10) prior produce or service purchases, and (11) prior advertisements selected for the participant during a prior videoconference.

The videoconferencing server 12 or the advertising sentiment processor 14 may be further configured to optionally communicate with a social media server 34 and access a social media account 36 of each (or at least one) of the one or more conference participants in order to obtain social media advertising sentiments for at least one of the one or more conference participants.

The advertising engine 14 selects the advertising for a unique conference participant based on one or more of (1) advertising sentiments detected or retrieved from sentiment artifact database 32 by the advertising sentiment processor 18 during the videoconference 28, (2) input from the unique conference participant's device 20, 22, 24, or 26 to the videoconferencing server 12, (3) current internet or social media activity on social media server 34 of the unique conference participant, and (4) information from the videoconference 28. The advertising engine 14 is configured to change the type of advertising, and the videoconferencing server 12 is configured to change the position of the advertising in the videoconference 28, based on one or more of (c) a change to the participant's advertising sentiment, (d) a command from the participant device of the participant, or an override by the videoconference host or other override. For example, an optional enterprise strategy that may override the selection of advertising based on participant advertising sentiment and/or videoconference information could be: (a) enterprise marketing strategy, e.g., products launched by an organization, or (b) corporate communications, e.g., bulletins.

The conference participant can, in order to view different advertising information or position advertising in a different location 38, 40, 42, 44, 46, or one of corners 48 in the videoconference 28 use any suitable technique, such as doing one or more of (a) using the GUI on the participant's participant device, (b) looking or swiping up, (b) looking or swiping down, (c) looking or swiping right, and (d) looking or swiping left.

The videoconferencing server 12 transmits menu settings to a participant device 20, 22, 24, or 26 of the conference participant, and the menu settings permit the conference participant to send commands to the videoconferencing server 12 to (1) add an advertisement, (2) reject an advertisement, (3) change an advertisement, (4) change the type of advertising, (5) change the position of the advertising in the video conference, or (6) suppress all advertising.

Each of the one or more conference participants can also, by using a respective GUI 20B, 22B, 24B, 26B on a participant device 20, 22, 24, 26 (1) purchase an advertised product or service, wherein information about the purchase can be stored in a storage 20A, 22A, 24A, or 26A, (2) share an advertisement with another of the one or more participant devices, or (3) bookmark an advertisement to be saved in a storage 20A, 22A, 24A, or 26A of the conference participant's device so the advertisement can be viewed later.

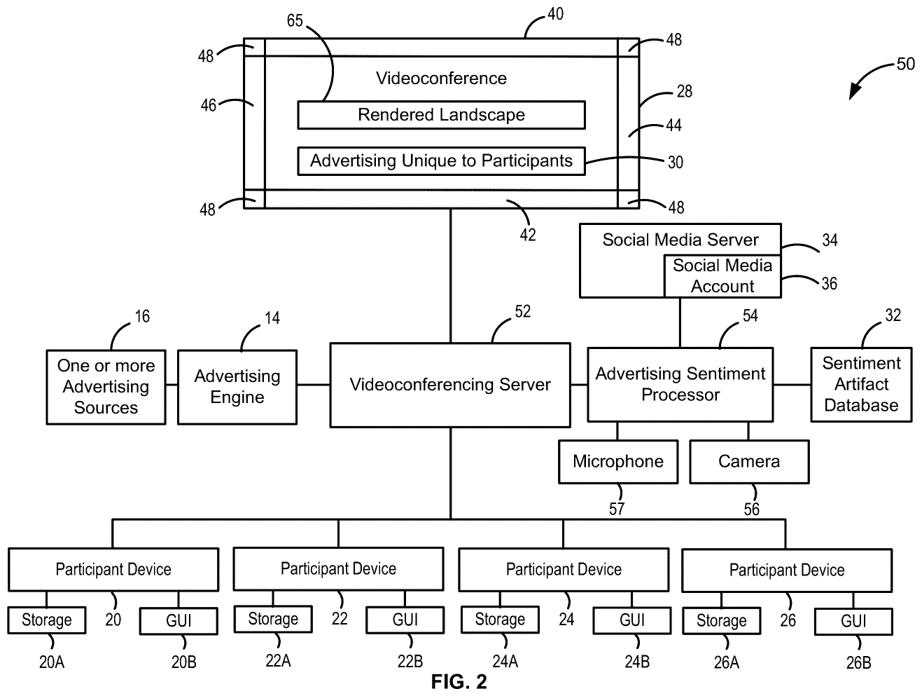

FIG. 2 shows an alternate system 50 according to aspects of this disclosure, which functions the same as system 10 except as described herein or shown in the Figures. System 50 includes a videoconferencing server 52 that is also configured to generate a videoconference 28. Videoconferencing server 52 is again in communication with one or more participant devices 20, 22, 24, and 26 and with advertising engine 14, which is in communication with and can access one or more advertising sources 16. In this embodiment, the advertising sentiment server is in direct communication with the videoconferencing server 52 and in indirect communication with advertising engine 14 through videoconferencing server 52.

Sentiment artifact database 32 and a social media server 34 with social media account 36 are in communication with advertising sentiment processor 54.

A camera 56 and microphone 58 are in communication with advertising sentiment processor 54. They are configured to transfer voice and video information to the advertising sentiment processor 54, which uses the information to help determine an advertising sentiment for at least one participant and transmits the sentiment to advertising engine 14 via videoconference server 52. The sentiment information gathered by camera 56 could be the participant's body language, facial position (e.g., watching the videoconference or looking away), and facial expressions (e.g., frowning, smiling, or nodding in approval). The sentiment information gathered by microphone 58 could be comments by the participant that are either negative, positive, supportive, unsupportive, approval, disapproval, or providing alternative suggestions of/for videoconference topics or the comments of other participants. System 10 may also include a camera and/or microphone. Advertising engine 14 uses the advertising sentiment to query one or more advertising sources 16 and select and display through videoconference server 52 advertising unique to the participant in videoconference 28. The advertising may appear at any suitable location in videoconference 28.

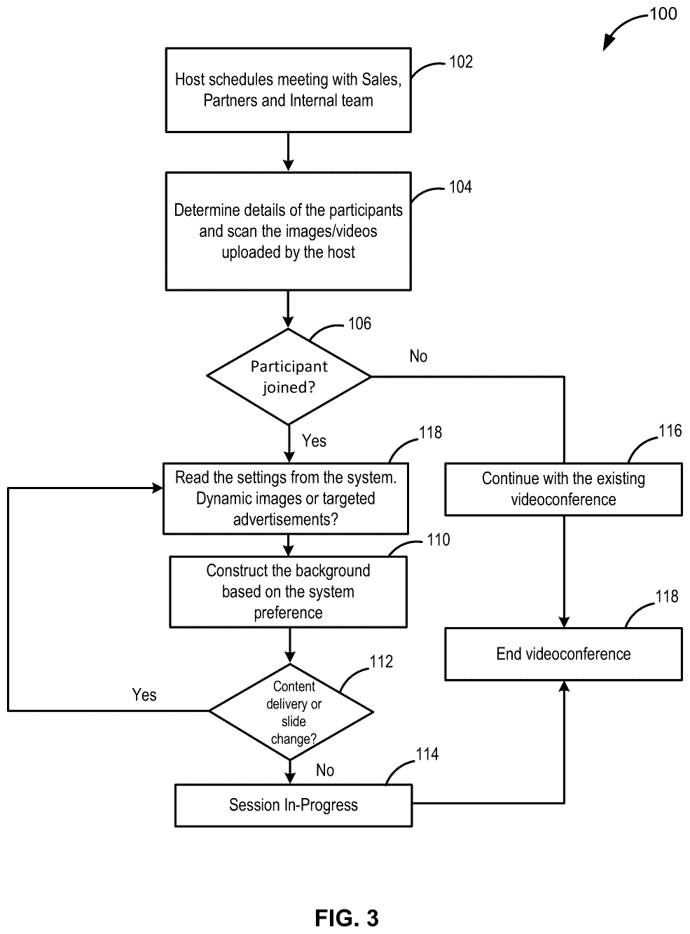

FIG. 3 illustrates a method 100 according to aspects of this disclosure. At step 102 a videoconference host schedules a meeting with the organization's sales partners and internal team. At step 104 the details of (i.e., advertising sentiment) the videoconference participants are determined and the videoconference images or videos are uploaded by the host. At step 106 a determination is made if a participant has joined the videoconference. If the participant has joined, the advertising sentiment of the participant is determined and at step 110 the system (such as system 10 or system 50) displays in the videoconference 28 on a participant device advertising unique to the participant based on the participant's advertising sentiment.

At step 112 the videoconferencing server 12 or 52 determines whether to deliver advertising content or change the slide of the videoconference. If the slide (or video image) has changed the method 100 repeats steps 108, 110, and 112. If the slide or video image has not changed, the videoconference session remains in progress at step 114 and ends at step 118. At step 106, if the participant has not joined, the videoconference continues at step 116 and ends at step 118.

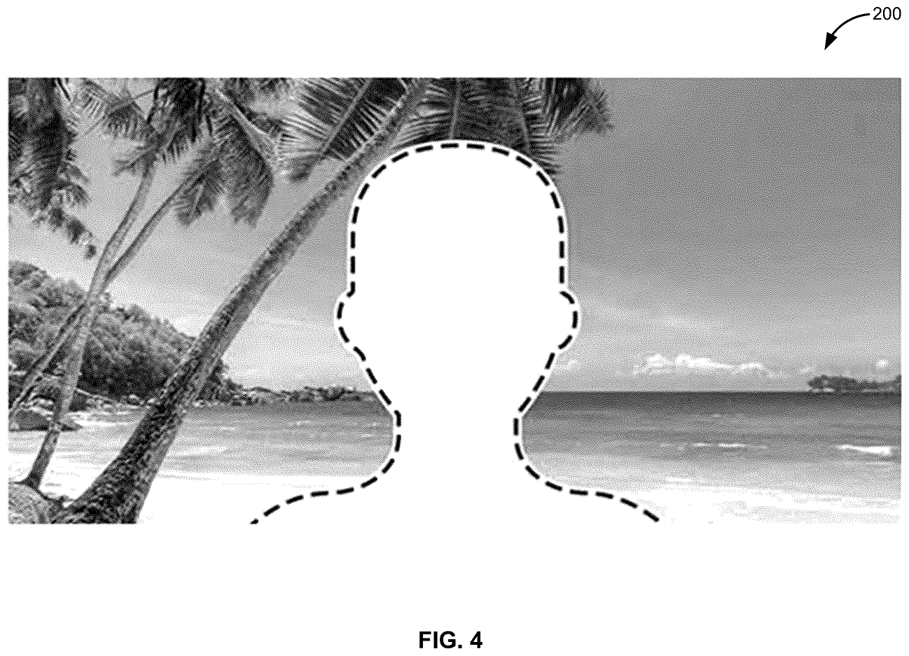

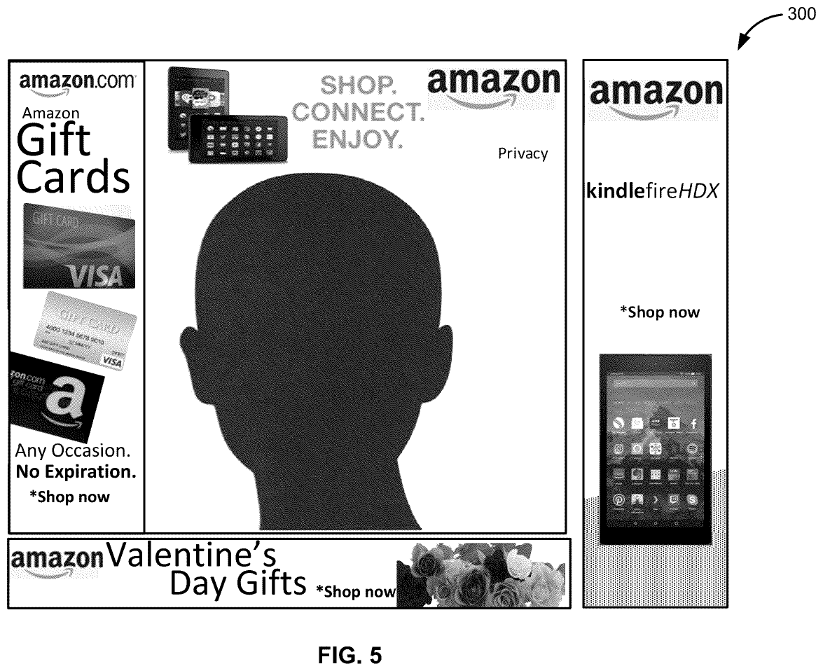

FIG. 4 depicts a participant seeing an advertisement with a beach scene during a videoconference 28. FIG. 5 depicts a conference host in black silhouette in a videoconference showing various possible advertisements at various possible locations on the videoconference screen.

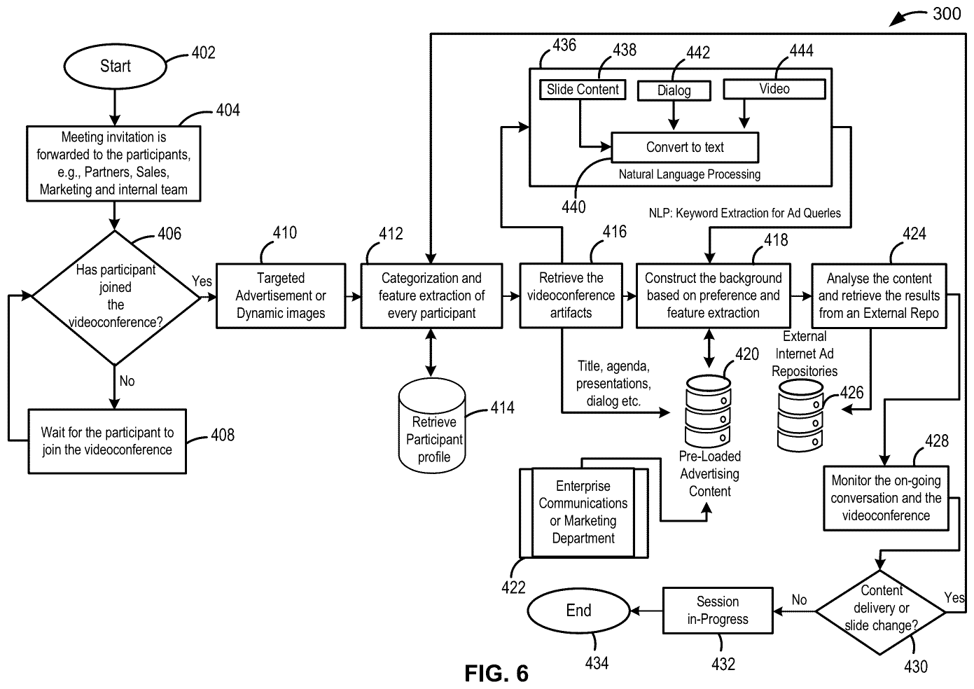

FIG. 6 shows an alternate method 400 according to aspects of this disclosure. The method starts at step 402 and at step 404 a meeting invitation is forwarded to, in this example, participants who are sales and marketing partners and internal marketing and sales team members. At step 406 the system 10 or 50 determines if a participant has joined the videoconference. If the participant has not jointed the videoconference, the system 10 or 50 can go to step 408 and wait for the participant to join the videoconference or move forward without that participant. If the participant has joined the videoconference targeted advertising or dynamic images are selected for the participant at step 410.

At step 412 an advertising sentiment (categorization and feature extraction) is determined for each participant as previously explained regarding system 10. If a participant profile already exists, it can be retrieved at step 414 and at step 412 the categorization and feature extraction of each participant is performed.

At step 416 the advertising sentiment processor 18 or 54 retrieves the videoconference artifacts, and at step 418 the videoconferencing server 12 or 52 constructs the background advertising for each participant, which is displayed on each participant's respective participant device 20, 22, 24, and 26. Pre-loaded advertising content at step 420 can be uploaded into the background advertising at step 418. The pre-loaded advertising content 420 could include enterprises communications or marketing department materials 422.

At step 424 the advertising content is analyzed and the results are retrieved from an external repository, which can be external internet or social media advertising 426. The system 10 or 50 then monitors the ongoing videoconference 28 at step 428 and makes a determination at step 430 whether to deliver advertising content or to make a slide change. The videoconference continues at step 432 and ends at step 434.

Optionally, at step 416, system 10 or 50 may convert videoconferencing content into text at step 436, which includes internal steps 438 and 440 of converting visual slide content to text, steps 442 and 440, which convert speech or dialog to text, and steps 444 and 440, which convert video to text. The text is then sent to advertising sentiment processor 18 or 54, or to advertising engine 14, and used to (1) gauge participant sentiment, and (2) search one or more advertising sources 16.

Supplementary advertising updates can occur whenever something is spoken about or manually tailored by the participants being engaged. For example, if Customer Enterprise X IT group is having a videoconference with an organization and is discussing artificial intelligence features, Enterprise X participants may see the artificial intelligence (AI) advertisements of Service Provider Y. In addition, or alternatively, the Service Provider Y audience could see Customer Enterprise X-related advertisements.

A videoconference host may also manually input the advertising prior to the videoconference so that appropriate advertising is displayed during the videoconference. For example, if a Company X participant interacts via email with a Customer Y about an upcoming sales event, when the next videoconference is booked, the Customer Y is invited to the videoconference and Company X advertising regarding the upcoming sales event is displayed. In such a method, (1) an advertising service, or advertising sentiment processor 18, can analyse email content on a connected server; (2) email recipients can be identified; (3) the videoconference is booked; (4) videoconference participants are matched with email data for each participant; (5) keywords may be identified from the email data; (6) the advertising sentiment processor 18 may query one or more advertising sources 16, which can include one or more organizational databases, based on the keywords; (a) advertising sentiment processor 18 accesses appropriate advertising from the one or more advertising sources 16; and (7) videoconference server 12 or 52 coordinates the placement of advertising so at least one of the participants can see the ad content on his/her participant device. Participants that see the advertising may have a stake in the sharing of targeted advertising being pushed by their own company.

Methods and systems according to the disclosure may be utilized in a vehicle, such as an Uber or a taxi, wherein the screens inside of the vehicle passenger area may reflect the interactions/communications of the passengers. For example, if a passenger is discussing purchasing a pizza, pizza ads, or other food ads, may be shown on a screen in the vehicle.

The description of embodiments provided herein is merely exemplary and is intended for purposes of illustration only; the following description is not intended to limit the scope of the claims. Moreover, recitation of multiple embodiments having stated features is not intended to exclude other embodiments having additional or fewer features or other embodiments incorporating different combinations of the stated features. The methods and systems according to this disclosure and claims can operate in a premise, cloud-based, or hybrid environment.

The features of the various embodiments may be stand alone or combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. These and other changes or modifications are intended to be included within the scope of the present invention, as expressed in the following claims.

What is claimed:

1. A videoconferencing system configured to generate a video conference including background advertising for one or more conference participants, the videoconferencing system comprising:
an advertising engine configured to communicate with advertising sources, wherein the advertising sources are one or more of a website, a social media site, and an advertising database in communication with the advertising engine;
a videoconferencing server in communication with the advertising engine and configured to generate a videoconference and communicate the video conference to one or more conference participant devices;
an advertising sentiment processor that (a) determines an advertising sentiment for each of one or more conference participants, and (b) selects unique advertising for each of the one or more of the conference participants based on the advertising sentiment, wherein the advertising sentiment processor is in communication with the advertising engine and with the video conferencing server; and
wherein the advertising engine is configured to obtain one or more unique advertisements from the advertising sources for each of the one or more conference participants based on the advertising sentiment for the each of the one or more conference participants and instruct the videoconferencing server to display one of the unique advertisements in the videoconference on each of the one or more conference participant devices.

2. The videoconferencing system of claim 1, wherein the advertising sentiment is based on one or more of the following of a conference participant: (1) monitoring the communication artifacts generated from various communication related applications such as Outlook email, Microsoft Teams or other videoconferencing software, Outlook Calendar, and others, (2) monitoring the language components to metadata for determining the targeted advertising, (3) participant designation (e.g., organizational title and/or meeting host or promoter), (4) content currently being spoken during the videoconference, (5) videoconference artifacts (title, headings, agenda, presentations, text, video, and/or images), (6) optional enterprise strategy (which can override the automated selection of advertising based on participant sentiment), wherein the enterprise strategy could be: (a) marketing strategy, e.g., products launched by an organization, or (b) corporate communications e.g., bulletins, (7) outside participant context, such as one or more of: (a) prior email conversations; (b) social media context; (c) chat forum (e.g., an agent on a website); (d) instant messaging; and (e) others.

3. The videoconferencing system of claim 1, wherein the videoconferencing server is in communication with a conferencing device of each of the one or more conference participants.

4. The videoconferencing system of claim 2, wherein the videoconferencing server or the advertising sentiment processor is further configured to communicate with a social media server and access a social media account of each of the one or more conference participants in order to obtain social media advertising sentiments for each of the one or more conference participants.

5. The videoconferencing system of claim 1, wherein the videoconferencing server is further configured to position the advertising in the videoconference in either the background, at a corner, at a bottom banner, at a top banner and/or at a side banner.

6. The videoconferencing system of claim 1, wherein the advertising engine selects the advertising for a unique conference participant based on one or more of (a) advertising sentiments detected by the advertising sentiment processor during the video conference, (b) input from the unique conference participant's device to the videoconferencing server, (c) preferences of the unique conference participant stored in the advertising sentiment database, and (d) current internet or social media activity of the unique conference participant.

7. The videoconferencing system of claim 1 that further includes a conference participant device for each of the one or more conference participants, wherein each conference participant device is configured to communicate with the videoconferencing server, and wherein each conference participant device includes a display configured to display the video conference and the unique advertising.

8. The videoconferencing system of claim 1, wherein the advertising engine is configured to cause the videoconferencing server to display the background advertising as one or more of (a) all or part of a rendered landscape, (b) a virtual agent that uses or discusses a product or service, (c) an image, (d) a video, (e) text, and (f) a sound.

9. The videoconferencing system of claim 1, wherein the advertising engine is configured to change (a) the type of advertising, or (b) position of the advertising in the videoconference, based on one or more of (c) a change to the advertising sentiment, or (d) a command from the conference participant device of the conference participant.

10. The videoconferencing system of claim 5, wherein the advertising in the background, at the corner, at the bottom banner, at the top banner and/or at the side banner can each be different for a same of the one or more conference participants.

11. A videoconferencing method operable on a video conferencing system, wherein the videoconferencing method is configured to generate a video conference including background advertising for one or more conference participants, and wherein the videoconferencing system comprises an advertising engine in communication with an advertising source, a videoconferencing server in communication with the advertising engine, and an advertising sentiment processor in communication with the videoconferencing server and with the advertising engine, the method comprising the steps of:
the videoconferencing server initiating a video conference;
the advertising sentiment processor determining an advertising sentiment for each of the one or more conference participants;
the advertising sentiment processor accessing the advertising engine and the advertising engine obtaining advertising for each of the one or more conference participants based on the advertising sentiment for each of the one or more conference participants and the advertising engine transmitting the advertising to the conference server; and
the conference server communicating the advertising in the video conference.

12. The videoconferencing method of claim 11, wherein each of the one or more conference participants can disable or enable the advertising engine with respect to advertising for that conference participant.

13. The videoconferencing method of claim 11, wherein each of the one or more conference participants has a conference device in communication with the videoconferencing server, wherein each conference device includes a camera configured to map the movement of the conference participant, and that further includes the step of the advertising sentiment processor altering the advertising based on the movement.

14. The videoconferencing method of claim 11, wherein a conference participant can (a) look or swipe up, (b) look or swipe down, (c) look or swipe right, and (d) look or swipe left, in order to view different advertising information or position advertising in a different location in the video conference.

15. The videoconferencing method of claim 11, wherein the videoconferencing server transmits menu settings to a device of each of the one or more conference participants; and the menu settings permit each of the one or more conference participants to send commands to the videoconferencing server to (a) add an advertisement, (b) reject an advertisement, (c) change an advertisement, (d) change the type of advertising, (e) change the position of the advertising in the video conference, or (f) suppress all advertising.

16. A videoconferencing system configured to create a video conference with background advertising unique to one or more conference participants, the videoconferencing system comprising:
an advertising engine configured to access advertising from the internet, social media, or an advertising database;
an advertising sentiment database that includes advertising sentiment information related to at least one of the conference participants, wherein the advertising sentiments include one or more of the conference participant's: (a) education, (b) work experience, (c) hobbies, (d) friends, (e) travel experiences and locations, (f) address, (g) age, (h) biometrics, (i) social media information, (j) prior purchases, and (k) prior advertisements shown during a video conference;
an advertising sentiment processor in communication with the advertising engine and with the advertising sentiment database, wherein the advertising sentiment processor is configured to determine an advertising sentiment for each of the one or more conference participants based at least in part based on the information in the advertising sentiment database, select an advertisement based on the advertising sentiment, and transmit the advertisement to the advertising engine, which obtains the advertisement;
a videoconferencing server in communication with the advertising sentiment processor and with the advertising engine and configured to receive the advertisement from the advertising engine and communicate the video conference with background advertising to a conference participant device of each of the one or more conference participants; and
wherein the background advertising is unique for each of the one or more conference participants.

17. The videoconferencing system of claim 16, wherein the videoconferencing server is configured to transmit a menu of settings visible on a screen of the customer device, wherein the menu settings are configured to permit the conference participant to select an advertisement, the method in which the advertisement is presented, and the location of the advertisement in the video conference.

18. The videoconferencing system of claim 16, wherein the videoconferencing server further includes a plurality of animated advertising agent figures and advertising agent voices from which a conference participant can select by transmitting a selection from a conference participant device to the videoconferencing server.

19. The videoconferencing system of claim 16, wherein the advertising changes if the advertising sentiment changes.

20. The videoconferencing system of claim 16 that is further configured such that each of the one or more conference participants can, by using the conference participant device (a) purchase an advertised product or service, (b) share a advertisement with another of the one or more conference participants, or (c) bookmark an advertisement to be saved on the conference participant's device so the advertisement can be viewed later.
